(19) United States
(12) Patent Application Publication
(10) Pub. No.: US 2016/0176460 A1
(43) Pub. Date: Jun. 23, 2016

(54) METHOD FOR MANUFACTURING VEHICLE COMPONENTS/STRUCTURAL COMPONENTS FROM A PLASTICS MATERIAL

(71) Applicant: MAGNA STEYR Fahrzeugtechnik AG & Co KG, Graz (AT)

(72) Inventors: Wolfgang DIETZ, Pirching (AT); Günter WOLFSBERGER, Lieboch (AT)

(21) Appl. No.: 14/978,853

(22) Filed: Dec. 22, 2015

(30) Foreign Application Priority Data
Dec. 22, 2014 (EP) 14199856.7
Jan. 30, 2015 (EP) 15153272.8

(51) Int. Cl. B62D 65/02

(52) U.S. Cl. CPC B62D 65/024

(57) ABSTRACT

A method for manufacturing and assembling motor vehicle components and structural components made from a plastics material. The method ensures a positioning of the vehicle components in the manufacturing process and in the assembly. The method uses a reference point system on the vehicle component which is introduced or applied during component production, the reference system having reference points in the form of recesses, depressions, elevations, edges, planar regions.

### CROSS-REFERENCE TO RELATED APPLICATIONS

The present application claims priority 35 U.S.C. §119 to European Patent Publication Nos. EP14199856.7 (filed on Dec. 22, 2014) and EP15153272.8 (filed on Jan. 30, 2015), which are each hereby incorporated by reference in their complete respective entireties.

### TECHNICAL FIELD

Embodiments relate to a method for manufacturing vehicle components or structural components from a plastics material.

### BACKGROUND

In the manufacture and assembly of vehicle components in the automotive industry, it is presently customary, in order to ensure a reliable and accurately repeatable positioning of the vehicle components and sub-assemblies, to employ a so-called reference point system. Such a reference point system is known by the designation RPS. This reference point concept enables a clear and reproducible positioning of individual parts, sub-assemblies, on the complete vehicle. Hence, in particular, tolerances of the vehicle components/sub-assemblies can be mutually coordinated and a reproducible position of the vehicle components can be attained throughout the manufacturing process.

The basis of the RPS is the fixing of specific point positions (reference points) on the vehicle components in order hereby to define the reference planes. The reference point system (RPS) is based on a vehicle coordinate system which has its origin centrally and level with the front axle of a vehicle. The reference points of an appropriate vehicle component on the one hand form a component-orientated coordinate system, which is important to the manufacturing method of the vehicle component, whilst on the other hand the position of the vehicle component in relation to other vehicle components, and also within the vehicle coordinate system, is fixed. The definition of the reference planes is realized via geometric elements, such as drill holes, edges or points on surface elements. In order that the reference planes are clearly defined, all six degrees of freedom must be fixed via the geometric elements on the corresponding vehicle component. The structure of a function-orientated reference point system based on the example of a car door can be gleaned from the article “Structure of a function-orientated reference point system as a tolerancing basis for a car body”, Dr.-Ing. Karin Spors, Dipl.-Ing Heiko Hennig, 9th. Symposium “Fertigungstechnisches Konstruieren” (Production Designing).

From German Patent Publication No. DE 100 48 774 B4, a door module and a method for the assembly of the door module is known. The door module here comprises the door module support, as well as the central part of the interior door lining. The interior door lining has a function unit, wherein in the function unit are provided reference points of the RPS for the positionally accurate assembly of the components. These reference points are realized as drill holes.

In addition, from German Patent Publication No. DE 10 2006 002 815 A1, a vehicle door and a method for its assembly with a RPS is known. The reference points of the RPS are formed by bolt-hole pairings. By the RPS, the functional position of the supporting plate on the interior door panel is defined and secured.

The vehicle components known from the aforementioned printed publications are realized as plastics components or metal components, into which the reference points realized as drill holes are introduced by drilling or milling. Nowadays, in the automotive industry, also fibre-reinforced plastics are used for vehicle components. This fibre-plastic composite is a material comprising reinforcement fibres and a plastics matrix. Due to the low density of the material and the extraordinary mechanical properties, this material is used for many vehicle components.

The introduction of drill holes or recesses in these materials, however, would bring about a destruction of the fibres, and thus a weakening of the vehicle component. At present, fibre composite components, principally by virtue of their shape and geometry, are positioned for further machining steps. This is frequently realized via manual work steps, which involves a lot of effort and signifies inexact reproducibility.

### SUMMARY

Embodiments relate to a method for manufacturing vehicle components/structural components and the like, which method is simple, and ensures simple and accurate positioning of the vehicle components or structural components in the manufacturing process and assembly, and wherein in the vehicle components or structural components to be produced, whether made from plastics materials or of fibre composites, the danger of structural weakenings is reduced.

Embodiments relate to a vehicle component which can be easily and exactly positioned, both in the manufacture and in the further assembly and a method for manufacturing a vehicle using such a vehicle component.

In accordance with embodiments, a method for manufacturing vehicle components and/or structural components from a plastics material comprises, providing a reference point system for the positioning of the vehicle components or structural components during manufacture, and/or positioning of the vehicle components or structural components during assembly with further vehicle components, and/or positioning of the vehicle components or structural components in the motor vehicle, wherein reference point system includes a plurality of reference points in the form of recesses, depressions, elevations, edges, planar regions.

In accordance with embodiments, a vehicle component or structural component made from a plastics material, which is manufactured according to the method for manufacturing, the vehicle component or structural component comprising a reference point system for the positioning of the vehicle components or structural components during manufacture, and/or positioning of the vehicle components or structural components during assembly with further vehicle components, and/or positioning of the vehicle components or structural components in the motor vehicle, wherein reference point system includes a plurality of reference points in the form of recesses, depressions, elevations, edges, planar regions.

In accordance with embodiments, a method for manufacturing a vehicle comprises positioning at least one vehicle component in reference to other vehicle components during manufacturing of the vehicle by using reference point system includes a plurality of reference points in the form of recesses, depressions, elevations, edges, planar regions.

In accordance with embodiments, a method for manufacturing a motor vehicle, comprising: providing, on a vehicle component composed of a plastic material, a reference point system for: (i) positioning of the vehicle component during manufacture; and/or (ii) positioning of the vehicle component during assembly with further vehicle components; and/or (iii) positioning the vehicle component in the motor vehicle, wherein the reference point system includes a plurality of reference points in the form of recesses, depressions, elevations, edges, planar regions on the vehicle component.

In accordance with embodiments, a motor vehicle, comprising: a vehicle component composed of plastic, and which has a reference point system thereon for: (i) positioning of the vehicle component during manufacture; and/or (ii) positioning of the vehicle component during assembly with further vehicle components; and/or (iii) positioning the vehicle component in the motor vehicle, wherein the reference point system includes a plurality of reference points in the form of recesses, depressions, elevations, edges, planar regions on the vehicle component.

In accordance with embodiments, a method for manufacturing a motor vehicle, comprising: positioning at least one vehicle component in reference to at least one other vehicle component by using at least one reference point of a reference system provided on the at least one vehicle component.

As a result of the method for manufacturing vehicle components and structural components from a plastics material, wherein the vehicle components have a multiplicity of reference points, it is possible to position the vehicle components in the manufacturing processes in the appropriate tools and receiving fixtures of the individual machining steps in a quick and reproducible manner by virtue of the reference point system. This is possible by virtue of the fact that the reference points are generated already in the course of the component manufacture, and may be created in the tool or the mould of the shaping process for the manufacture of the vehicle component from a plastics material.

Furthermore, as a result of the reference points on the manufactured or semi-finished vehicle component by way of the reference point system, a reliable positioning in the process of manufacturing a component and/or in the further process of installing a sub-assembly or installing or positioning a sub-assembly on the complete vehicle is possible. The same reference points can be used for both the manufacture and the assembly. The positioning in the X/Y/Z plane on the basis of the reference points allows a uniform and reliable positioning of the vehicle components in a fully automated manufacturing process. By way of example, press-moulding during curing, positioning during contour or milling machining, positioning of bonding/connecting/assembling steps, relative positioning of the vehicle components in the complete vehicle, are cited as process steps. As can be seen from the representation relating to embodiments, a plurality, such as, for example, three reference points may be provided on the vehicle component.

Vehicle components or structural components are of planar construction and have a plane contour or a three-dimensional contour predefined by the respective design. By vehicle components or structural components are understood both larger and smaller components, such as, for example, hollow profiles, longitudinal members. As already described herein, these vehicle components/structural components are produced in a manufacturing process from plastics or a fibre-reinforced plastics material. In the manufacture of the fibre composite materials, laminates comprising a plurality of semi-finished fibre products lying one above the other (woven fabrics, non-woven fabrics, mats, fleece) with different fibre direction are frequently produced. Known methods are manual laying methods, in which semi-finished fibre products are placed into a mould and impregnated with synthetic resin and deaerated by pressing and subsequently cured.

In addition, prepreg technology is known. Here the pre-impregnated fibre mats are placed onto the mould. The material composite is next deaerated via a vacuum bag and subsequently cured in the autoclave under pressure and temperature. Instead of a laminar fibre composite component, a sandwich component with core can also be manufactured as a vehicle component.

A further method for manufacturing plastics components and for manufacturing fibre composite materials is injection moulding. In the manufacture of vehicle components from a fibre composite material, the fibre-containing plastics material is melted in the extruder and injected into the mould and cured.

Advantageously, the mould for manufacture of the vehicle components can here be constructed according to one of the aforementioned methods such that, at predefined places on the surface forming the vehicle component, shaping elements in the form of recesses, depressions, elevations are provided, wherein the reference points are formed on the vehicle component by these shaping elements. A further option for the formation of such reference points on the vehicle component is the introduction of additional components into the still liquid composite material. The additional components can be configured as inlays, inserts or onserts. As the material for the additional components, wood, metal (for instance iron or non-ferrous metals), plastic, etc. are used.

An advantage of the abovementioned formation of the reference points already in the curing tool or in the shaping manufacture of the fibre composite component in accordance with the aforementioned methods, is that no structural weakening or structural destruction caused by subsequent material-removing machining, such as, for example, subsequent introduction of drill holes in the region of the reference points, occurs. A weakening of the force lines present in the component is hereby avoided.

Similarly, the formation of the reference points is realized without destruction or damaging of the fibres possibly present in the plastics material. Given the introduction of additional components into the still liquid matrix of the fibre composite material, the fibres can wrap around, or envelop or entwine the additional components. This applies, in particular, if the additional component is pressed into the still soft fibre composite material.

If the reference points are formed by shaping elements provided in the forming tool, destruction or damaging or tearing of the fibres is prevented, since the plastics material is soft during the formation of the reference points and the fibres in the soft composite can still yield. If onserts are used, an additional component is introduced into a cavity provided for the purpose in the forming tool and is press-moulded with the still soft fibre composite component via a forming tool. The onsert here connects to the fibre composite component or is bonded thereto. The fibre layers here remain undamaged or the onsert is glued onto the fibre layer or the covering layer without displacing the fibres or without significantly displacing the fibres and thus influencing the force flow direction.

In accordance with embodiments, the term “plastics materials” embraces both thermoplastic plastics, such as, for example, polypropylene, polycarbonate, polyethylene, etc., and duroplastic plastics, or both thermoplastic and duroplastic fibre-reinforced plastics (fibre composite materials). As fibre composite materials are termed composite materials or material composites comprising a matrix material or matrix system with embedded fibres. Due to this composite, the tensile strength of the fibres in the fibre direction can be utilized in conjunction with the option of shaping by the matrix. As the matrix material, thermoplastic plastics, such as polypropylene (PP), polyamide (PA), polycarbonate (PC), or else duroplastic plastics, such as epoxy resin, unsaturated polyesters (UP), polyurethane (PUR), etc., can for instance be used. As the fibres, glass fibres, carbon fibres, ceramic fibres, natural fibres, textile fibres, etc., can be used. Fibre composite components can here be realized both in the form of laminates or connected laminate layers and as sandwich components, with different cores.

In accordance with embodiments, the covering layers are made of a fibre composite material and the core layer can comprise, for instance, of a cellular or foamed material, for instance of polyurethane (PUR). The core material can comprise, for instance, plastic, paper or metals. If cellular cores are used, all honeycomb forms, for instance honeycomb-shaped, rectangular, square, round, polygonal, wavy etc., can be considered.

These reference points may be realized as notches, grooves, beads, elevations, impressions, recesses or the like, but also by additional components such as inlays, inserts or onserts.

Further advantageous embodiments and refinements of the method according to the invention for the manufacture and/or assembly of vehicle components, structural components from a plastics material emerge from the sub-claims.

### DRAWINGS

Embodiments will be illustrated by way of example in the drawings and explained in the description below.

FIG. 1 illustrates a vehicle component with reference points in a side view, in accordance with embodiments.

FIG. 2 illustrates a detail of a cross-section through a forming tool during manufacture of a multilayered vehicle component in accordance with embodiments, in which the reference points are formed by embossment.

FIG. 3 illustrates a detail of a cross-section through a forming tool during manufacture of a multilayered vehicle component in accordance with embodiments, in which the reference points are formed by inserts.

FIG. 4 illustrates a detail of a cross-section through a forming tool during manufacture of a multilayered vehicle component in accordance with embodiments, in which the reference points are formed by inlays.

FIG. 5 illustrates a detail of a cross-section through a forming tool during manufacture of a multilayered vehicle component in accordance with embodiments, in which the reference points are formed by onserts.

FIG. 6 illustrates a detail of a cross-section through a forming tool during manufacture of a multilayered vehicle component in accordance with embodiments, in which the reference points are formed by onserts.

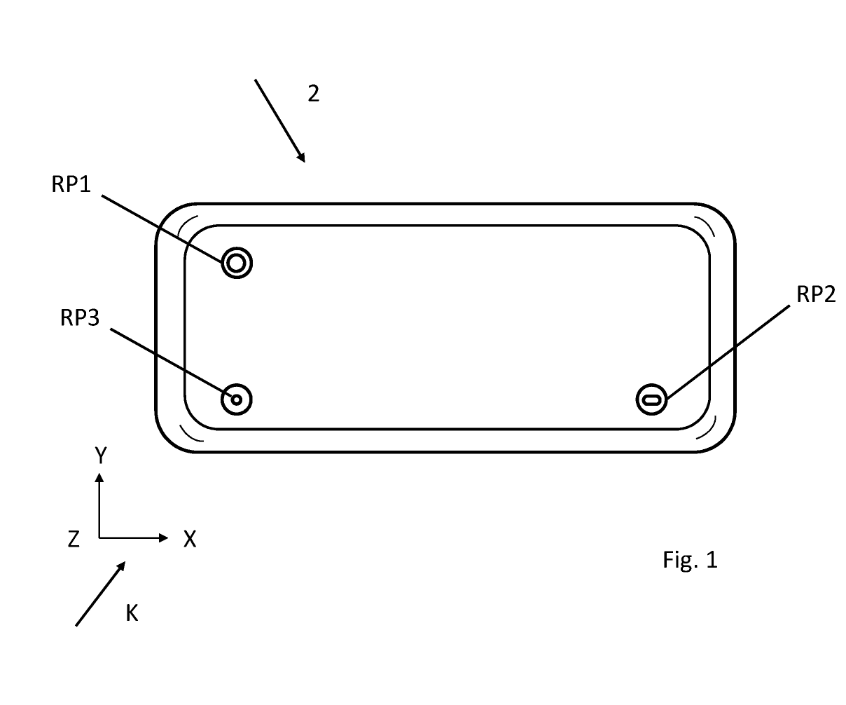

### DESCRIPTION

The vehicle component 2 is designed as a planar shaped part and has a three-dimensional surface formation defined by the respective design. The vehicle component 2 comprises appropriately configured reference points RP1, RP2 and RP3 of the predefined reference point system RPS. The reference points are here realized as circular depressions, wherein in the depression is respectively realized an additional depression. The reference point RP1 has as the additional depression a further circular depression of lesser diameter. By the RP1, the X, Y, Z directions are defined. The reference point RP2 has as the additional depression a depression in the form of a long hole. By the RP2, the X, Z or Y, Z directions are defined. The reference point RP3 has as the additional depression a small, round notch. By the RP3, the Z direction is defined. The X, Y, Z directions are fixed by the coordinate system K.

As a result of the above-stated reference points RP1, RP2 and RP3, a clear relative positioning of the components to be assembled, and a clear positioning of the components in the complete vehicle, is ensured.

The vehicle components may be made from a plastics material, and can be manufactured, for instance, in a known injection moulding process.

For the manufacture of the vehicle component 2, an injection mould, comprising an upper and lower tool half, may be used.

In an initial process step, using an injection mould (which is not represented diagrammatically), top and bottom tool halves are brought together so that a closed cavity is formed.

In a further process step, a plasticized fibre-reinforced plastic is next injected into the cavity via a number of injection nozzles. The formation of the vehicle component 2 is realized at high temperatures (dependent on the material, for instance, at 240 degrees in the case of polypropylene) and at a pressure which is selected in accordance with/dependence on the selected material, the flow path and the wall thickness (in the case of polypropylene, about 600 bar). As a result, the plastic is distributed in the cavity. The top and/or bottom tool is/are here realized, on the predefined surface regions to be formed on the vehicle component, with shaping elements. These shaping elements are, for example, elevations, depressions, impressions or embossments, domes etc., which, in the above-described injection moulding process, at predefined places on the vehicle component, give rise to reference points in the form of recesses, elevations, etc. Instead of the formation of shaping elements in the region of the mould, also additional components such as inlays, inserts or onserts can be positioned at the predefined places in the tool.

In an alternative manufacturing method, a multilayered vehicle component 2 with reference points is produced. For the manufacture of the vehicle component 2, a core material 3 is firstly either coated or encased on the top and bottom side with dry fibre mats 4a, 4b and impregnated, sprayed and/or wetted with a matrix material, or coated with prepregs or pre-impregnated semi-finished fibre products. After this, the stack, or the so-called layup, is compression moulded in a heated, unipart or multipart compression moulding tool and preferably cured in the tool.

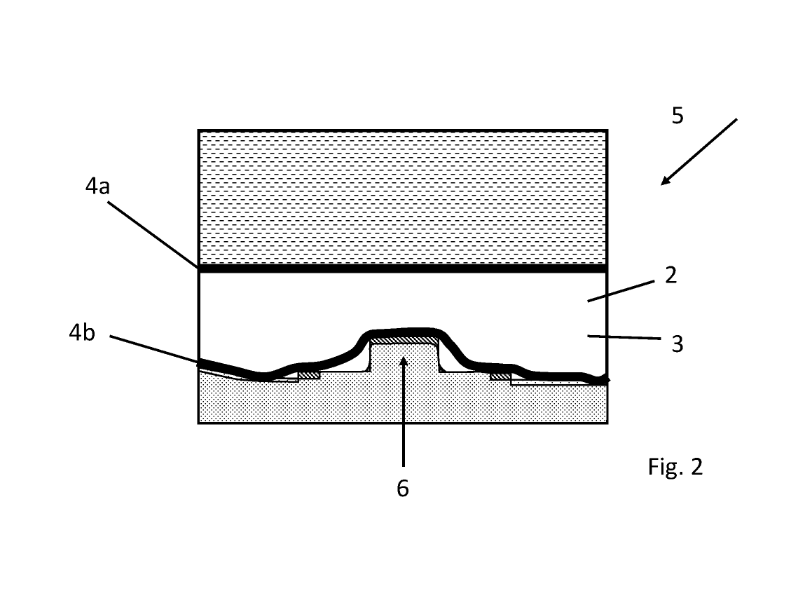

As illustrated in FIG. 2, the inserted stack or the layup of fibre mats 4a, 4b and core layer 3 is shown during press-moulding in a mould 5. The mould 5 has an upper tool half 5a and a lower tool half 5b. The lower tool half 5b has predefined surface regions with shaping elements 6. In accordance with embodiments, these shaping elements are realized as elevations and have a tin-like geometry in cross section. As can be seen from the sectional representation, the fibres of the lower fibre mat 4a, in the course of the press-moulding of the fibre composite component, come to bear against the edges of the lower mould 5b in the region of the shaping elements 6, but are not hereupon damaged. On the corresponding surface region of the fibre composite component/vehicle component 2, the predefined reference points are thus formed.

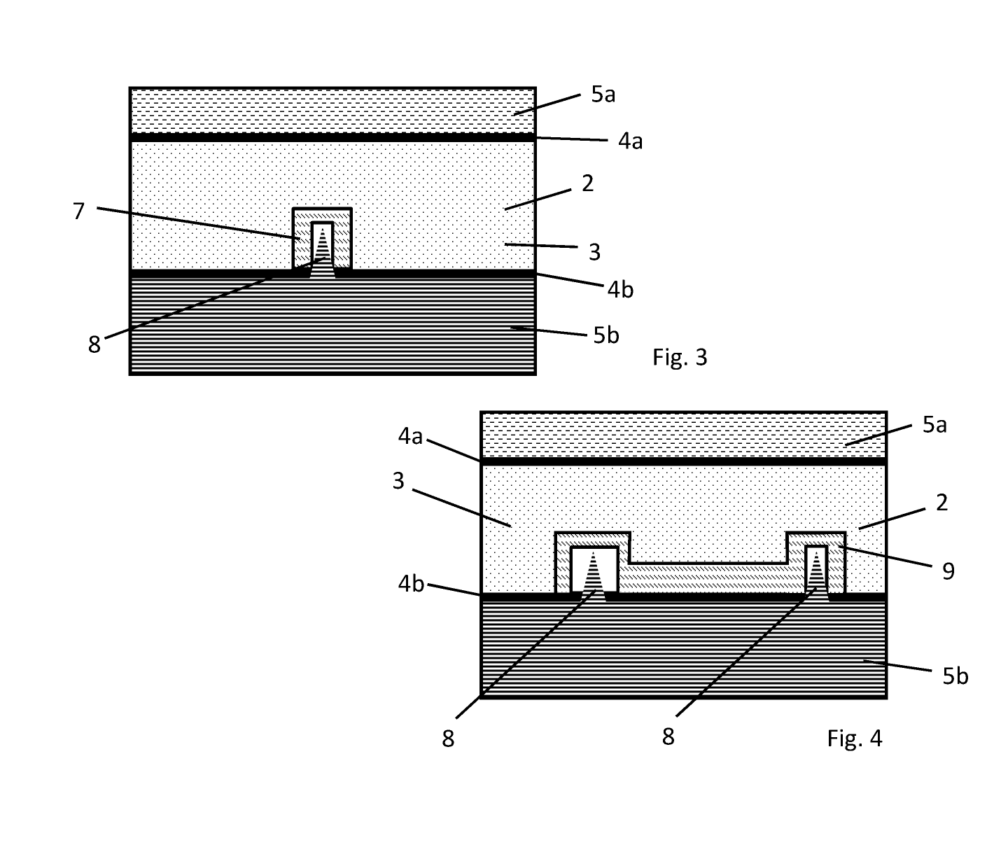

As illustrated in FIG. 3, a forming tool with upper and lower tool half 5a, 5b during manufacture of a multilayered vehicle/fibre composite component 2 in a second embodiment, in which the reference points are formed by inserts 7. The inserts 7 are jointly inserted into the mould additionally to that stack/layup of covering layers 4a, 4b and core layer 5 which is to be press-moulded. A positioning of the inserts is here realized via position pins 8 arranged in the mould. In the course of the press moulding, the inserts 7 are pressed into the multilayered vehicle component. The fibre layer is locally displaced at this place, but not interrupted.

As illustrated in FIG. 4, a forming tool with upper and lower tool half during manufacture of a multilayered vehicle component/fibre composite component in a third embodiment, in which the reference points are formed by inlays 9. Inlays 9 are advantageous when attachment points of considerable strength have to be introduced into the vehicle component 2. This is necessary in connection with the fastening of hinges, locks and the like.

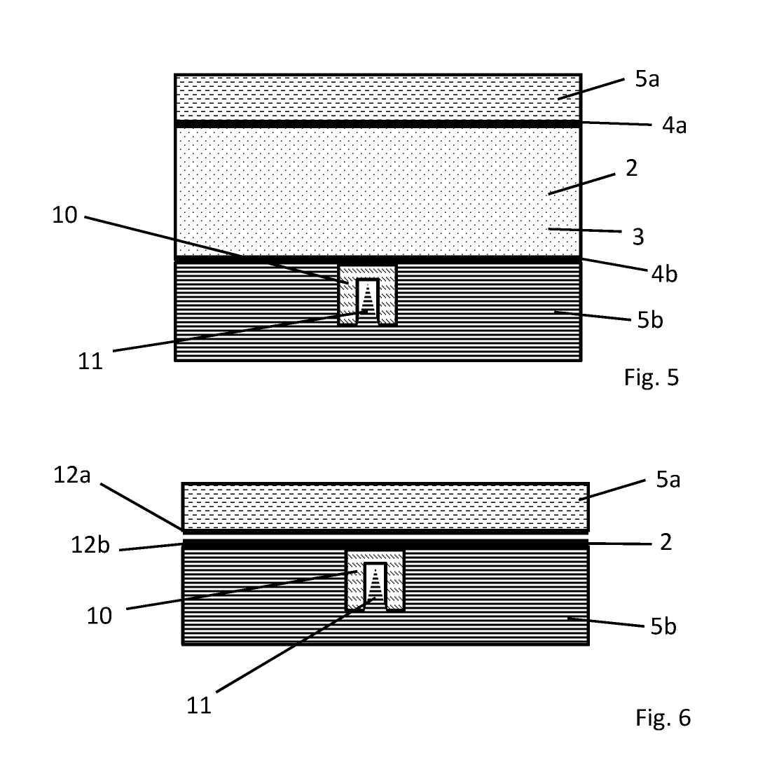

As illustrated in FIG. 5, a forming tool with upper and lower tool half 5a, 5b during manufacture of a multilayered vehicle/fibre composite component 2 in a fourth embodiment, in which the reference points are formed by onserts 10. The onserts 10 are positioned in depressions in the mould via additional position pins 11. In addition to the onserts, the stack to be press moulded, or the layup of covering layers 4a, 4b and core layer 5 which is to be press moulded, comprising, is jointly placed into the mould. A positioning of the inserts is here realized via position pins 11 arranged in the mould. In the course of the press moulding, the onserts 10 are then pressed onto the surface of the multilayered vehicle component 2 and stick there.

As illustrated in FIG. 6, a forming tool with upper and lower tool half 5a, 5b during manufacture of a multilayered vehicle/fibre composite component 2 in a fifth embodiment, in which the reference points are formed by onserts 10. The onserts 10 are positioned in depressions in the mould via additional position pins 11. In addition to the onserts, the stack of two fibre layers 12a, 12b which is to be press moulded is jointly placed into the mould. A positioning of the onserts is here realized via position pins 11 arranged in the mould. In the course of the press moulding, the onserts 10 are then pressed onto the surface of the multilayered vehicle component 2 and stick there.

As is explained in greater depth further above, the vehicle components can also be produced via other known manufacturing methods. It is here of fundamental importance that the reference points in the form of recesses, elevations, indentations, additional components such as inlays, inserts or onserts are created already in the curing tool (mould) or during the shaping manufacture of the vehicle component from the actual plastics material, in particular the actual fibre composite material itself.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

What is claimed is:

1. A method for manufacturing a motor vehicle, the method comprising:
providing, on a vehicle component composed of a plastic material, a reference point system for:
positioning of the vehicle component during manufacture; and/or
positioning of the vehicle component during assembly with further vehicle components; and/or
positioning the vehicle component in the motor vehicle,
wherein the reference point system includes a plurality of reference points in the form of recesses, depressions, elevations, edges, planar regions on the vehicle component.

2. The method of claim 1, wherein the reference points are formed in shaping of the vehicle component in a mould.

3. The method of claim 2, wherein forming the reference points on the vehicle component comprising providing the mould with shaping elements configured in the form of elevations, depressions, impressions, and domes.

4. The method of claim 2, wherein in the forming of the reference points on the vehicle component, additional components are positioned in the mould.

5. The method of claim 4, wherein the additional components comprise wood, metal, and plastics materials.

6. The method of claim 1, wherein the reference points comprise circular depressions.

7. The method of claim 6, wherein in each of the circular depressions an additional depression of lesser diameter is provided and has the form of a hole.

8. The method of claim 1, wherein the plastics material comprises a fibre composite material.

9. The method of claim 8, wherein the vehicle components are manufactured from fibre composite materials as laminates or sandwich components.

10. The method of claim 8, wherein the vehicle component is formed via at least one of injection moulding, pressing, injection, curing in the autoclave, and deaeration via vacuum bags.

11. A motor vehicle, comprising:
a vehicle component composed of plastic, and which has a reference point system thereon for:
positioning of the vehicle component during manufacture; and/or
positioning of the vehicle component during assembly with further vehicle components; and/or
positioning the vehicle component in the motor vehicle,
wherein the reference point system includes a plurality of reference points in the form of recesses, depressions, elevations, edges, planar regions on the vehicle component.

12. The motor vehicle of claim 11, wherein the vehicle component comprises a laminate of fibre composite materials or a sandwich component.

13. A method for manufacturing a motor vehicle, comprising:
positioning at least one vehicle component in reference to at least one other vehicle component by using at least one reference point of a reference system provided on the at least one vehicle component.

14. The method of claim 13, wherein the at least one reference point system is in the form of recesses, depressions, elevations, edges, planar regions on the vehicle component.
